(19) United States
(12) Patent Application Publication
(10) Pub. No.: US 2026/0142462 A1
(43) Pub. Date: May 21, 2026

(54) ENERGY OPTIMIZATION FOR LOAD PEAK SHAVING WITH MICROGRID CONTROL SYSTEMS

(71) Applicant: Caterpillar Inc., Peoria, IL (US)

(72) Inventors: Bradley Paul OHLROGGE, Peoria, IL (US); Gregory Scott HASLER, Pekin, IL (US); Sowmya NAGESH, Peoria, IL (US)

(73) Assignee: Caterpillar inc., Peoria, IL (US)

(21) Appl. No.: 18/955,603

(22) Filed: Nov. 21, 2024

(51) Int. Cl. H02J 3/00; H02J 3/38

(52) U.S. Cl. CPC H02J 3/003; H02J 3/004; H02J 3/381; H02J 2101/30; H02J 2103/35

(57) ABSTRACT

A microgrid controller may store performance data associated with each fuel-based energy resource system provided in a microgrid; calculate, based on the load information, a total load demand required by a plurality of loads; calculate a set of optimization parameters based on the performance data, the set of optimization parameters being configured to optimize a performance of the microgrid; determine load setpoints for the fuel-based energy resource systems and the one or more energy storage systems based on the set of optimization parameters; and generate, based on the load setpoints and the total load demand, control signals for operating the fuel-based energy resource systems and the one or more energy storage systems.

### TECHNICAL FIELD

The present disclosure relates generally to microgrids and, for example, to a microgrid controller configured to control or manage an operation of a microgrid.

### BACKGROUND

A microgrid is a self-sufficient energy system that serves a particular geographic area, such as a college campus, a hospital complex, a business center, a neighborhood, a mining site, a drilling site, and/or the like. Within a microgrid are one or more kinds of distributed energy resources (DERs) (e.g., solar panels, wind turbines, fuel cells, photovoltaic (PV) cells, generators, energy storage devices (e.g., batteries, capacitors), and/or other energy sources) that produce power for the microgrid. Some microgrids are configured as off-grid electrical power distribution systems (e.g., stand-alone microgrids or islands) that do not connect to a larger electrical power distribution system (e.g., a macrogrid) run by, for example, an electric utility or power plant. Some microgrids are able to operate in a grid-connected mode and in a stand-alone mode. In a grid-connected mode, a microgrid may operate connected to and synchronous with the larger electrical power distribution system. In a stand-alone mode, the microgrid may be disconnected from the larger electrical power distribution system and operate as a stand-alone microgrid. A microgrid controller may control whether the microgrid operates in the grid-connected mode or in the stand-alone mode based, for example, on a schedule or on one or more conditions being satisfied.

Minimizing grid power draw and using fuel-based DERs, such as generator sets, at optimal efficiency to meet peak load demand is an issue at drill sites, mine sites, and consumer energy operations. Many microgrid systems do not have an efficient way to manage operations of the fuel-based DERs due to each fuel-based DER having unique performance characteristics. This may be especially true for an operating environment in which power demands from loads are dynamically changing. As a result, an efficiency of the microgrid may suffer based on operating the fuel-based DERs at sub-optimal performance.

U.S. patent publication No. 2024/0127370 (“the '370 publication”) discloses a dispatch optimization system and virtual power plant that can be utilized and controlled in order to support operations of a power distribution system. For example, the '370 publication discloses that upon determining an electrical need, the dispatch optimization system and/or virtual power plant may make an energy adjustment by allocating the energy adjustment among distributed energy resources of a fleet of distributed energy resources in order to achieve the energy adjustment. The dispatch optimization system and/or virtual power plant may determine the allocation among the distributed energy resources based on the economic costs and storage costs to use each distributed energy resource. However, the '370 publication does not disclose optimizing a microgrid based on performance curves of fuel-based DERs, such as generator sets.

The microgrid system of the present disclosure solves one or more of the problems set forth above and/or other problems in the art.

### SUMMARY

A microgrid controller of a microgrid may include a communication interface configured to receive load information corresponding to a plurality of loads connected to the microgrid, receive energy resource information corresponding to a plurality of energy resource systems connected to the microgrid, and output control signals for controlling an operation of each energy resource system of the plurality of energy resource systems, wherein the plurality of energy resource systems includes one or more fuel-based (FB) energy resource systems configured to generate power to be supplied to the microgrid and one or more energy storage systems (ESSs) configured to be charged and discharged; one or more memories configured to store performance data associated with each FB energy resource system of the one or more FB energy resource systems; and one or more processors, coupled to the one or more memories, configured to: calculate, based on the load information, a total load demand required by the plurality of loads, calculate a set of optimization parameters based on the performance data, the set of optimization parameters being configured to optimize a performance of the microgrid, determine load setpoints for the one or more FB energy resource systems and the one or more ESSs based on the set of optimization parameters, and generate the control signals based on the load setpoints and the total load demand.

A microgrid controller of a microgrid may include a communication interface configured to receive load information corresponding to a plurality of loads connected to the microgrid, receive energy resource information corresponding to a plurality of energy resource systems connected to the microgrid, and output control signals for controlling an operation of each energy resource system of the plurality of energy resource systems, wherein the plurality of energy resource systems includes one or more FB energy resource systems configured to generate power to be supplied to the microgrid and one or more ESSs configured to be charged and discharged; one or more memories configured to store performance data associated with each FB energy resource system of the one or more FB energy resource systems; and one or more processors, coupled to the one or more memories, configured to: calculate, based on the load information, a total load demand required by the plurality of loads, calculate optimization setpoints based on the performance data, wherein the optimization setpoints are calculated for operating each FB energy resource system of the one or more FB energy resource systems at a respective peak efficiency over a range of total load demand, and generate the control signals based on the optimization setpoints and the total load demand.

A method for controlling assets of a microgrid may include receiving, by a microgrid controller of a microgrid, load information corresponding to a total load demand of a plurality of loads connected to the microgrid; receiving, by the microgrid controller, energy resource information corresponding to a plurality of energy resource systems configured to supply power to the microgrid, wherein the plurality of energy resource systems includes one or more FB energy resource systems configured to generate power to be supplied to the microgrid and one or more ESSs configured to be charged and discharged; receiving performance data associated with each FB energy resource system of the one or more FB energy resource systems; monitoring, in real-time, based on the load information, the total load demand of the plurality of loads; calculating optimization setpoints based on the performance data, wherein the optimization setpoints are calculated for operating each FB energy resource system of the one or more FB energy resource systems at a respective peak efficiency over a range of total load demand; and generating the control signals based on the optimization setpoints and the total load demand.

### BRIEF DESCRIPTION OF THE DRAWINGS

FIG. 1 shows a system according to one or more implementations.

FIG. 2 shows a microgrid according to one or more implementations.

FIG. 3 is a flowchart of an example process associated with energy optimization for load peak shaving with microgrid control systems.

FIG. 4 is a diagram of example components of the microgrid controller energy optimization for load peak shaving with microgrid control systems.

### DETAILED DESCRIPTION

This disclosure relates to a power distribution system, and is applicable to any system that distributes and/or receives power via a power grid. Some aspects relate to a microgrid controller that is configured to control one or more components and/or systems associated with the microgrid, including energy resource systems and/or loads. The microgrid controller may control a state of the microgrid based on one or more conditions being satisfied.

Many microgrid systems do not have an efficient way to operate fuel-based DERs, such as generator sets, at optimal efficiency to meet peak load demands and to minimize grid power draw from a macrogrid or a utility. Drawing grid power may increase an operating cost of a microgrid. In addition, grid power may not be available in remote locations. Each fuel-based DER may have unique performance characteristics. Thus, each fuel-based DER may respond differently to dynamically changing power demands. As a result, operating the fuel-based DERs at optimal efficiency may depend on each of the fuel-based DER's unique performance characteristics, a total load demand, and other types of DERs included in the microgrid. In some cases, fuel-based DERs may be used to charge energy storage type DERs, such as energy storage systems (ESSs), which should be taken into account for operating the fuel-based DERs at optimal efficiency. As a result, an efficiency of the microgrid may suffer based on operating the fuel-based DERs at sub-optimal performance.

Some implementations described herein are directed to a microgrid system in which a plurality of energy resource systems are provided, including one or more fuel-based energy resource systems configured to generate power to be supplied to the microgrid system and one or more ESSs configured to be charged and discharged. The fuel-based energy resource systems may be generator sets, such as diesel engine-generators. A microgrid controller may be configured to control operations within the microgrid system. The microgrid controller may store performance data, associated with each fuel-based energy resource system, that may be used to operate the fuel-based energy resource systems at optimal efficiency to satisfy total load demands of the microgrid system.

The microgrid controller may identify optimized calibrations for the microgrid system based on performance curves of the plurality of energy resource systems. For example, the microgrid controller may identify optimized calibrations for the microgrid system based on performance curves of the fuel-based energy resource systems. The performance curves may include, for each fuel-based energy resource system, a generator power performance curve, a brake mean effective pressure (BMEP) performance curve, a break specific fuel consumption (BSFC) performance curve, and/or a volumetric fuel consumption (VFC) performance curve. A generator power performance curve for a diesel engine may represent a relationship between the diesel engine's output power and the diesel engine's speed or load. A BMEP performance curve for a diesel engine may represent a relationship between the diesel engine's BMEP and the diesel engine's speed or load. A BSFC performance curve may represent a relationship between a diesel engine's fuel efficiency (e.g., BSFC) and the diesel engine's speed or load. A VFC performance curve may represent a relationship between a diesel engine's fuel consumption rate (in terms of volume) and the diesel engine's operating conditions, typically measured across different engine speeds or loads.

The performance curves may be unique to each fuel-based energy resource system. For example, the performance curves may correspond to manufacturer specifications of the fuel-based energy resource systems. Thus, the microgrid controller may store performance data (e.g., performance curves) associated with each fuel-based energy resource system for optimizing operations of the fuel-based energy resource systems based on the total load demand. In addition, the microgrid controller may use the performance data to optimize operations of the fuel-based energy resource systems based on the operational statuses of the ESSs.

The microgrid controller may use a mean performance point of the performance curves to calculate optimization setpoints for the microgrid system. The optimization setpoints may be adjusted at a local controller or at the microgrid controller to optimize a microgrid performance, including a reduction in fuel consumption. In addition, an efficiency factor may be provided by an operator or a commissioning engineer. The efficiency factor may be used by the microgrid controller or the local controller to calculate and/or tune the optimization setpoints. The microgrid controller may use the optimization setpoints to determine when to add or drop one or more energy resource systems, to determine when to trigger a fast addition of one or more energy resource systems to meet a (steep) transient load, to determine minimum and maximum load thresholds of one or more energy resource systems, and/or to determine state-of-charge (SOC) thresholds or setpoints for when the ESSs should be set for charging, to absorb power from the microgrid, or discharging, to provide power to the microgrid. The microgrid controller may provide energy optimization for load peak shaving. The microgrid controller may be configured to size a battery capacity of the ESSs and a number of fuel-based energy resource systems to manage peak demand and costs.

The microgrid controller may determine the optimization setpoints to enable each fuel-based energy resource system (e.g., each engine of the fuel-based energy resource systems) to run at peak efficiency. The optimization setpoints may be load setpoints that each trigger a respective action based on the total load demand. For example, the load setpoints may include at least one of: an energy resource add setpoint for triggering the microgrid controller to add a first additional energy resource system to the microgrid based on the total load demand satisfying the energy resource add setpoint, an energy resource shed setpoint for triggering the microgrid controller to shed an energy resource system from the microgrid based on the total load demand satisfying the energy resource shed setpoint, a fast add setpoint for triggering the microgrid controller to add a second additional energy resource system to the microgrid based on detecting a transient load that satisfies the fast add setpoint, a minimum load setpoint for indicating a minimum load to be allocated, by the microgrid controller, to each fuel-based energy resource system, a maximum load setpoint for indicating a maximum load to be allocated, by the microgrid controller, to each fuel-based energy resource system, or an SOC setpoint for triggering the microgrid controller to discharge the one or more ESSs based on an SOC of the one or more ESSs satisfying the SOC setpoint.

The optimization setpoints may enable the microgrid controller to allow full utilization of ESSs in conjunction with the fuel-based energy resource systems to minimize fuel usage of the fuel-based energy resource systems by allowing the fuel-based energy resource systems to run at respective peak efficiency points. For example, up to 34% in fuel savings may be realized.

In some implementations, a human-machine interface (HMI) may be integrated with and/or communicably coupled to the microgrid controller. The HMI may include one or more processors or controllers configured to store the performance data (e.g., performance curves) associated with each fuel-based energy resource system for optimizing operations of the fuel-based energy resource systems based on the total load demand. In addition, the HMI may use the performance data to optimize operations of the fuel-based energy resource systems based on the operational statuses of the ESSs. The HMI may transmit commands to the microgrid controller for controlling the fuel-based energy resource systems and the ESSs. In some implementations, the HMI may calculate the optimization setpoints and provide the optimization setpoints to the microgrid controller. Thus, the HMI may be an external controller that provides commands and/or optimization setpoints to the microgrid controller.

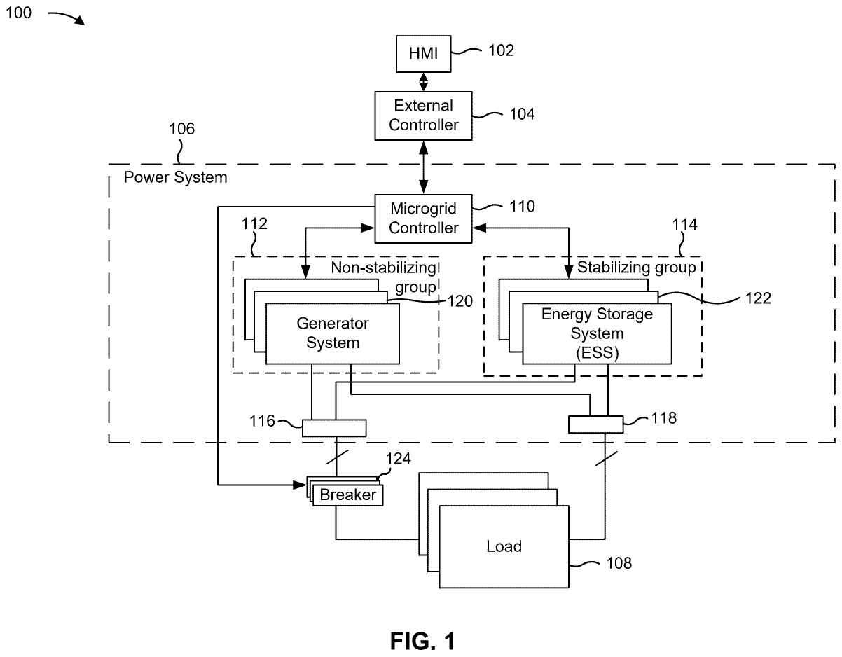

FIG. 1 shows a system 100 according to one or more implementations. The system 100 may include a human-machine interface (HMI) 102, an external controller 104, a power system 106, and one or more loads 108.

The power system 106 may be a microgrid or other type of electrical power distribution system that may provide power to the one or more loads 108. In some cases, the power system 106 may be an off-grid electrical power distribution system. In some cases, the power system 106 may be configurable to operate in a grid-connected mode and in a stand-alone mode. The power system 106 may include a microgrid controller 110, a non-stabilizing group of energy resource systems 112 (e.g., a non-stabilizing group of DERs), a stabilizing group of energy resource systems 114 (e.g., a stabilizing group of DERs), and interfaces 116 and 118. Generally, “off-grid” may mean that the electrical power distribution system is not connected to a larger electrical power distribution system run by, for example, an electric utility or other large-scale electric power generation plant that serves electricity to a geographic area, campus, compound, etc. However, techniques disclosed herein may still be applied to electrical power distribution systems that are connected to larger electrical power distribution systems. For instance, the larger electrical power distribution systems may operate as a power source in a primary provider role or secondary provider role, while the power system 106 may operate as a power source in the other of the primary provider role or secondary provider role.

The non-stabilizing group of energy resource systems 112 may include one or more energy generator systems 120. Each energy generator system 120 may include a power generator (e.g., an engine-generator, a fuel cell, a PV cell, or other power generating system) and a local generator controller communicatively coupled to the microgrid controller 110. Thus, each energy generator system 120 may generate power from a respective power source. Each local generator controller may control how much power a respective power generator generates, control a rate of power distribution, and/or obtain status information corresponding to the respective power generator. Each local generator controller may be controlled by the microgrid controller 110.

An engine-generator, such as a diesel engine-generator, may be referred to as a generator set or genset that uses a fuel-based engine that consumes fuel to generate power. Thus, an engine-generator may be referred to as a fuel-based (FB) energy resource system. The non-stabilizing group of energy resource systems 112 may include one or more FB energy resource systems that operate according to performance data, such as one or more performance curves. The performance data may correspond to manufacturer specifications for the fuel-based engine. For example, the performance data may include generator power data, BMEP data, BSFC data, and/or VFC data. The performance data may be provided in one or more performance curves, such as a generator power performance curve, a BMEP performance curve, a BSFC performance curve, and/or a VFC performance curve.

The stabilizing group of energy resource systems 114 may include one or more energy storage systems (ESSs) 122. Each energy storage system 122 may include an electric storage device (e.g., one or more batteries and/or capacitors) and a local ESS controller communicatively coupled to the microgrid controller 110. Each local ESS controller may control a flow of power into or out of a respective electric storage device, including charging of the respective electric storage device and discharging of the respective electric storage device, control a rate of power flow, and/or obtain status information corresponding to the respective electric storage device, such as state-of-charge (SOC), state-of-health (SOH), discharge limit, and other device parameters. Each local ESS controller may be controlled by the microgrid controller 110.

The system 100 may also include one or more breakers 124 (e.g., distribution breakers or switches) that may be individually controlled by the microgrid controller 110 to connect a respective load 108 to the power system 106 or disconnect the respective load 108 from the power system 106. The one or more breakers 124 may be part of one or both interfaces 116 and 118.

The HMI 102 may include one or more processors, and may be configured to receive and process one or more inputs from a user, such as an operator. Additionally, the HMI 102 may be configured to provide one or more prompts or outputs to the user. Thus, the HMI 102 may be a user terminal configured to interact with a user to process information and/or commands provided by the user, provide information to the user (e.g., status information), and/or perform one or more tasks or functions in response to processing the information and/or commands provided by the user. The HMI 102 may be communicatively coupled to the external controller 104, which may be communicatively coupled to the microgrid controller 110. In some implementations, the HMI 102 may be communicatively coupled directly to the microgrid controller 110. The external controller 104 may send commands to and receive information from the microgrid controller 110. For example, the external controller 104 may send commands to the microgrid controller 110 based on information received from the HMI 102. Thus, the external controller 104 may be a user-commanded controller. The external controller 104 may be integrated with the HMI 102. The external controller 104 may be a controller of a larger electrical power distribution system (e.g., a macrogrid, a power generation plant, and/or electric utility provider).

The power system 106 may provide electrical power to the one or more loads 108. Generally, the power system 106 may provide alternating current (AC) power at a particular voltage and a particular current. The microgrid controller 110 may control one or more energy storage systems 122 to instantaneously inject power when power is needed by the power system 106 or instantaneously absorb surplus power generated by the power system 106. Accordingly, one of more electric storage devices of the energy storage systems 122 may act as a power consumer on one or more energy generator systems 120 or as a power source for the one or more energy generator systems 120, to thereby ensure that system bus frequencies of the non-stabilizing group of energy resource systems 112 are maintained at a nominal value. In other words, the microgrid controller 110 may control the stabilizing group of energy resource systems 114 to stabilize loads of the non-stabilizing group of energy resource systems 112 in order to maintain the non-stabilizing group of energy resource systems 112 at a relatively constant load, which may reduce a recurrence of frequency deviations from the nominal value.

The microgrid controller 110 may be integrated with, or separate from (but connected to), the interfaces 116 and 118, the energy generator systems 120, and the energy storage systems 122, or combinations thereof. In this manner, a user may, through interaction with the HMI 102, add or remove energy generator systems 120 to increase/reduce system power generation and/or add or remove energy storage systems 122 to increase/reduce system energy storage capacity, in accordance with a user's preference. For instance, a user may prefer to add additional energy generator systems 120 and/or add additional energy storage systems 122 to increase load capacity if additional loads 108 are expected to be connected to the power system 106, or remove energy generator systems 120 and/or remove energy storage systems 122 to decrease load capacity if loads 108 are expected to be disconnected from the power system 106. Additionally, the microgrid controller 110 may be configured to add or remove energy generator systems 120 and/or add or remove energy storage systems 122 from the power system 106 based one or more conditions being satisfied. In some cases, the microgrid controller 110 may be configured to add or remove energy generator systems 120 and/or add or remove energy storage systems 122 from the power system 106 based on a schedule.

The one or more loads 108 may be any device that can connect to a power distribution system, such as the power system 106, to receive electrical power. Examples of loads may include heavy machinery (e.g., electric mining machines, haulers, etc.), personal devices, appliances, heating, ventilation, and air conditioning (HVAC) systems, industrial drills, personal residence electrical distribution systems, etc. The loads 108 may include one or more non-stable loads, such as one or more cyclic loads. The loads 108 may include unidirectional loads (e.g., loads that can only receive power from the power system 106), bi-directional loads (e.g., loads that can both receive power from the power system 106 and provide power to the power system 106), charging loads (e.g., loads that include a chargeable electric battery), essential loads (e.g., loads that require uninterrupted service), and/or non-essential loads (e.g., loads that do not require uninterrupted service). Loads may be assigned different priorities based on load type, load classification, and/or operation state or mode.

Generally, the one or more loads 108 may receive the power from the power system 106 and use the power in accordance with the operations of the one or more loads 108. Users of the power system 106 and the one or more loads 108 may connect/disconnect the one or more loads 108 by electrically connecting the one or more loads 108 to the interfaces 116 and 118 of the power system 106. For instance, the interfaces 116 and 118 may have AC plugs/sockets to connect the one or more loads 108 in parallel to the one or more energy generator systems 120 and the one or more energy storage systems 122 of the power system 106. One or more loads 108 may include a local load controller that may collect load information and transmit the load information to the microgrid controller 110. Load information may include information indicating a load type, a load classification, and/or an operation state or mode of a load 108. The loads can be active (real) or reactive to allow for a power quality-based approach to scheduling. Load information may include load data of a load, such as maximum load and minimum load. For chargeable loads, load information may include maximum charging load, maximum state of charge, minimum state of charge, current state of charge, and usable discharge energy as a function of the current state of charge. Load information may be received by the microgrid controller 110 via the interfaces 116 and 118, which may include one or more communication interfaces coupled to the microgrid controller 110.

The interfaces 116 and 118 may also have a plurality of generator connections and a plurality of energy store connections. The plurality of generator connections may be hardwired electrical connections and/or AC plugs/sockets to connect the one or more energy generator systems 120 in parallel to the at least one load 108 and the one or more energy storage systems 122. The plurality of energy store connections may be hardwired electrical connections and/or AC plugs/sockets to connect the one or more energy storage systems 122 in parallel to the one or more loads 108 and the one or more energy generator systems 120. For instance, the power system 106 may or may not allow addition/removal of energy generator systems 120 and/or addition/removal of energy storage systems 122. Therefore, depending on a configuration, the interfaces 116 and 118 may include: (1) hardwired electrical connections that connect the at least one energy generator system 120; (2) AC plugs/sockets to connect/disconnect the at least one energy generator system 120; (3) hardwired electrical connections that connect the at least one energy storage system 122; and/or (4) AC plugs/sockets to connect/disconnect the at least one energy storage system 122. The interfaces 116 and 118 may be coupled to a system bus (e.g., a power bus) of the power system 106. The system bus may enable one of more of the energy storage systems 122 to absorb power from one or more energy generator systems 120 and/or one or more loads 108 (e.g., for charging and/or storing power).

The one or more energy generator systems 120 may also include communication interfaces. The communication interfaces of the one or more energy generator systems 120 may enable the one or more energy generator systems 120 to communicate with the microgrid controller 110. For instance, the one or more energy generator systems 120 may be connected to the microgrid controller 110 by wired or wireless communication. The one or more energy generator systems 120 may provide the microgrid controller 110 with generator data (e.g., energy resource information). The generator data, for each of the one or more energy generator systems 120, may include load data and/or generator parameters. The load data may include a current (e.g., instantaneous) load seen by the one or more energy generator systems 120 and/or past load data (if one or more energy generator systems 120 store such data locally). The current load/past load data may include voltage (e.g., in volts) and/or current (e.g., in amperes) measured by one or more sensor components included in an energy generator system 120. The generator parameters may include a generator set maximum threshold value and a generator set minimum threshold value. Alternatively, to reduce transmission bandwidth, the generator data may omit the generator parameters, and the one or more energy generator systems 120 may transmit the generator parameters during an initial configuration process between the one or more energy generator systems 120 and the microgrid controller 110. The generator set maximum threshold value and the generator set minimum threshold value may indicate a maximum power load and a minimum power load, respectively, that a generator of an energy generator system 120 may support.

The one or more energy storage systems 122 may be any energy storage device that can store and output AC power. For instance, the one or more energy storage systems 122 may include at least one electrical-chemical energy storage (e.g., a battery), electrical energy storage (e.g., a capacitor, a supercapacitor, or a superconducting magnetic energy storage), mechanical energy storage (e.g., a fly wheel, a pump system), and/or any combination thereof. The one or more energy storage systems 122 may include inverters (individually or collectively) so that the one or more energy storage systems 122 may operate as a power consumer or a power source. The one or more energy storage systems 122 may also include electronic control mechanisms to control (1) how much load the one or more energy storage systems 122 draw, or (2) how much AC power the one or more energy storage systems 122 output.

The one or more energy storage systems 122 may also include communication interfaces. The communication interfaces of the one or more energy generator systems 120 may enable the one or more energy storage systems 122 to communicate with the microgrid controller 110. For instance, the one or more energy storage systems 122 may be connected to the microgrid controller 110 by wired or wireless communication. The one or more energy storage systems 122 may provide the microgrid controller 110 with energy storage data (e.g., energy resource information) and may receive instructions from the microgrid controller 110.

The energy storage data may include, for each of the at least one energy store, a current energy level (e.g., kilowatt-hours currently stored), total energy storage capacity (e.g., kilowatt-hours of capacity), and/or discharge/charge parameters. The current energy level may be measured by a battery meter of an energy storage. The battery meter may one or combinations of a voltmeter, an amp-hour meter, and/or an impedance-based meter. The discharge/charge parameters may indicate an amount of discharge power and an amount of charge power for a respective energy storage device of the one or more energy storage systems 122. Alternatively, to reduce transmission bandwidth, the energy storage data may omit the discharge/charge parameters, and the one or more energy storage systems 122 may transmit the discharge/charge parameters when the one or more energy storage systems 122 are first connected to the microgrid controller 110.

The one or more energy storage systems 122 may receive requests (e.g., instructions) for the energy storage data to provide the energy storage data and/or continuously provide the energy storage data to the microgrid controller 110. The instructions may include energy storage dispatch (ESD) instructions. An ESD instruction may include an instruction to inject power to a system bus of the power system 106 or absorb power from the system bus of the power system 106. ESD instructions may be provided in control signals (e.g., communication signals that provide the ESD instructions). At least one ESD instruction may be utilized to rapidly stabilize the load, thereby stabilizing the bus frequency of the power system 106 in a time efficient manner, rather than attempting to stabilize the load using the one or more energy generator systems 120 alone. The one or more energy storage systems 122 may control the inverters and the electronic control mechanisms to control (1) quantity of load drawn by the one or more energy storage systems 122, or (2) the amount of AC power output produced by the one or more energy storage systems 122, in accordance with the ESD instructions. Reactive and/or active may be used as a qualifier for loads, where reactive loads may contribute to a stabilization algorithm in addition to the active or real loads.

The microgrid controller 110 may include at least one memory device (e.g., one or more memories) for storing instructions (e.g., program code); at least one processor for executing the instructions from the memory device to perform a set of desired operations; and a communication interface (e.g., coupled to a communication bus) for facilitating the communication between various system components. The instructions may be computer-readable instructions for executing a control application. The communication interface of the microgrid controller 110 may enable the microgrid controller 110 to communicate with the one or more energy generator systems 120 and the one or more energy storage systems 122. The microgrid controller 110, while executing the control application, may receive the generator data and the energy storage data (e.g., energy resource information), process the generator data and the energy storage data to generate one or more ESD instructions, and output the ESD instructions to one or more energy generator systems 120 and/or to one or more energy storage systems 122.

To process the generator data and the energy storage data to generate the ESD instructions, the control application may include a load stabilization function and/or an SOC function. The control application may also include a generator set limit function and/or energy store discharge/charge limit function to generate the ESD instruction. In some cases, the load stabilization function may be activated while the power system 106 is configured in stand-alone mode in order to provide off-grid load stabilization. The microgrid controller 110 may automatically activate or deactivate the aforementioned system functions based on a presence or an absence of system parameters (such as no generator set minimum threshold value being available, etc.) or one or more system conditions being satisfied.

Generally, the load stabilization function may ensure that system bus frequencies of the one or more energy generator systems 120 are maintained at a nominal value by causing an amount of power to be absorbed/injected by the one or more energy storage systems 122. The amount of power may be determined based on a difference from an instantaneous load and a moving average of the load. Meanwhile, the SOC function may ensure that the one or more energy storage systems 122 are charged to a target SOC or a target SOC range such that a SOC of one or more energy storage systems does not drift too low or too high, outside of a desired operating range (e.g., the target SOC range). The target SOC or the target SOC range may enable the at least one energy storage system 122 to provide long term beneficial use to the system 100, such as having a range of operation usable by the power system 106 and/or avoid degradation ranges of the one or more energy storage systems 122.

One or more energy generator systems 120 may include an engine-generator (e.g., a genset) that provides AC power to the power system 106, which may provide the AC power to the at least one load 108. Generally, an engine-generator may be any device that converts motive power (mechanical energy) into electrical power to output the AC power. An engine-generator may be a gas turbine electrical generator. In such gas turbine electrical generators, fast changes in load from the at least one load 108 may cause a system bus frequency to deviate from a nominal value. The system bus frequency may be a frequency of electrical components of the generator. For instance, such gas turbine electrical generators may have isochronous frequency control governors that may try to maintain the system bus frequency to the nominal value in response to changes of the load of the one or more loads 108. Therefore, during a transient load charge (e.g., a load transient), the system bus frequency may change as the load on the engine-generator changes. However, a rate of return of the system bus frequency back to the nominal value is slower than a desired rate due to an inertia of motion of physical components (e.g., a rotor of a stator-rotor) of the engine-generator. The slow rate of return may reduce power quality of the power system 106. The power quality of the power system 106 may be determined based on the voltage, frequency, and waveform of the power output to the one or more loads 108. A high power quality may ensure continuity of service for the one or more loads 108, such that the one or more loads 108 are able to properly function as intended. A low power quality may cause the one or more loads 108 to malfunction, fail prematurely, or not operate at all.

Therefore, avoiding load transients may be beneficial in providing better power quality. However, generally, controlling a load of the one or more loads 108 may not be possible or desirable. Instead, the microgrid controller 110 may control the one or more energy storage systems 122 of the stabilizing group of energy resource systems 114 to act as a power consumer or as an energy source, so that the one or more energy generator systems 120 of the non-stabilizing group of energy resource systems 112 may maintain the system bus frequency at the nominal value, thereby ensuring better power quality.

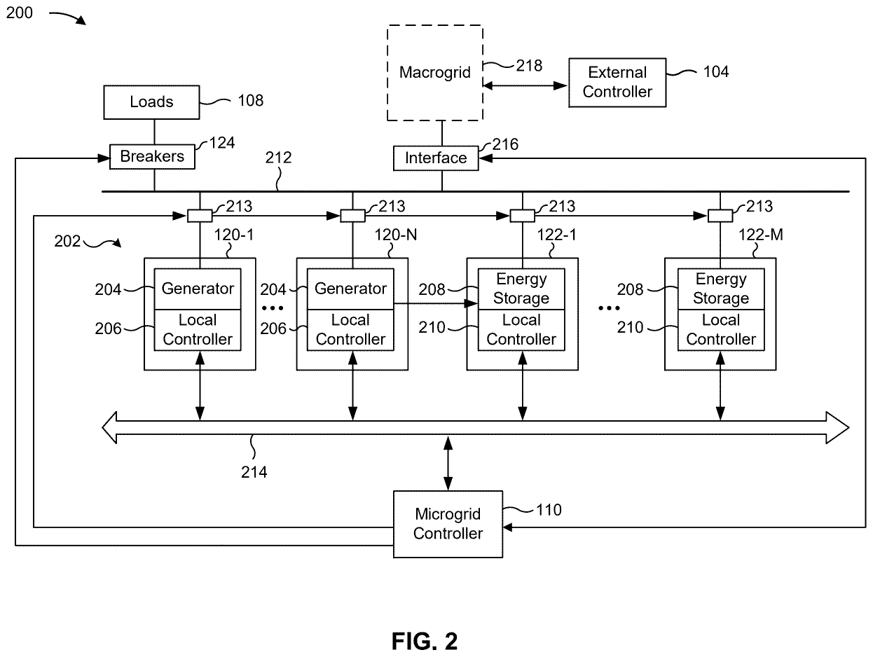

FIG. 2 shows a microgrid 200 according to one or more implementations. The microgrid 200 may be an example of the power system 106 described in connection with FIG. 1. The microgrid 200 may include a plurality of DERs 202. The plurality of DERs 202 may include N energy generator systems 120 and M energy storage systems 122, where N and M are integers greater than zero. For example, the plurality of DERs 202 may include a first energy generator system 120-1 and an N^{th} energy generator system 120-N. In the example, shown in FIG. 2, the N energy generator systems 120 may be FB energy resource systems, such as engine-generators. Additionally, the plurality of DERs 202 may include a first energy storage system 122-1 and an M^{th} energy storage system 122-M. Each energy generator system 120 may include a power generator 204 (e.g., an engine) and a local generator controller 206. Each energy storage system 122 may include an electric storage device 208 (e.g., one or more batteries and/or capacitors) and a local ESS controller 210. The microgrid 200 may include additional types of generator systems that are not illustrated in FIG. 2. For example, the microgrid 200 may include solar panels, wind turbines, fuel cells, and/or PV cells.

Each energy generator system 120 may be coupled to a power bus 212 for providing power to one or more loads connected to the power bus 212. Additionally, each energy storage system 122 may be coupled to the power bus 212 for providing power to or absorbing power from the power bus 212 (e.g., for providing power to or absorbing power from one or more components, such as one or more loads and/or one or more energy generator systems 120 connected to the power bus 212).

The microgrid 200 may also include the microgrid controller 110 that is communicatively coupled to the local controllers (e.g., local generator controllers 206 and local ESS controllers 210) of each DER 202 across a communication bus 214. The communication bus 214 may also enable the microgrid 200 to communicate with one or more loads and/or one or more load management systems (e.g., charging systems, fleet management systems, local load controllers, etc.). In some cases, two or more communication buses 214 may be provided. For example, one communication bus may be provided to communicate with local controllers and another communication bus may be provided to communicate with one or more loads and/or one or more load management systems.

Each local generator controller 206 may include any appropriate hardware, software, and/or firmware to sense and control a respective power generator 204, and send information to, and receive information, from microgrid controller 110. For example, a local generator controller 206 may be configured to sense, determine, and/or store generator data of its respective power generator 204. The generator data may be sensed, determined, and/or stored in any conventional manner. Each local generator controller 206 may control whether a respective power generator 204 is connected to or disconnected from the power bus 212 (for example, based on an instruction or a control signal received from the microgrid controller 110).

Each local ESS controller 210 may include any appropriate hardware, software, and/or firmware to sense and control a respective electric storage device 208, and send information to, and receive information, from microgrid controller 110. For example, a local ESS controller 210 may be configured to sense, determine, and/or store various characteristics of its respective electric storage device 208. Such characteristics of the respective electric storage device 208 may include, among others, a current SOC, a current energy, an SOC minimum threshold, an SOC maximum threshold, and a discharge limit of the respective electric storage device 208. These characteristics of each respective electric storage device 208 may be sensed, determined, and/or stored in any conventional manner. Each local ESS controller 210 may control whether a respective electric storage device 208 is connected to or disconnected from the power bus 212 (for example, based on an instruction or a control signal received from the microgrid controller 110).

The microgrid controller 110 may receive or determine a need for charging or discharging of power from the microgrid 200, and may be configured to determine and send signals to allocate a total charge request and/or total discharge request across all of the plurality of DERs 202.

When performing the power allocation functions, the microgrid controller 110 may allocate a certain amount of power from each energy generator system 120 to one or more loads 108. The one or more loads 108 may be connected to the power bus 212 via one or more breakers 124 to receive power from the power bus. When performing the power allocation functions, the microgrid controller 110 may allocate a total charge request and/or a total discharge request across the energy storage systems 122 as a function of a usable energy capacity of each energy storage system 122. The usable energy capacity corresponds to the capacity or amount of energy that an energy storage system 122 can receive in response to a total charging request (usable charge energy), or the capacity or amount of energy that an energy storage system can discharge in response to a total discharge request (usable discharge energy). The usable charge energy is a function of a maximum state of charge, current state of charge, and current energy of the energy storage system, and the usable discharge energy is a function of a minimum state of charge, and current energy of the energy storage system 122. The microgrid controller 110 may determine a usable charge/discharge capacity of each energy storage system 122 (e.g., SOC), a desired charge/discharge of each energy storage system 122, a remainder power of each energy storage system 122, and/or an SOH of each energy storage system 122.

Thus, the microgrid controller 110 regulates a power supply of the microgrid 200 such that an exact amount of desired power flows into or out of the power system 106 at any given time. The microgrid controller 110 may regulate the power supply of the microgrid 200 in cooperation with the local generator controllers 206 and the local ESS controllers 210. The microgrid controller 110 may transmit control signals (e.g., instructions) to the local generator controllers 206 and the local ESS controllers 210 to activate (e.g., to bring online), deactivate (to bring offline), or curtail (limit or regulate to a target output) one or more of the DERs 202. Additionally, or alternatively, the microgrid controller 110 may transmit control signals to one or more switches 213 to control a switch state (e.g., an on state or an off state) of the one or more switches 213, for example, to connect one or more DERs 202 to or disconnect one or more DERs 202 from the microgrid 200 (e.g., the power bus 212). The switches 213 may be integrated in one or both interfaces 116 and 118 described in connection with FIG. 1.

In some cases, two or more power buses 212 may be provided. For example, a power bus may be provided to couple one or more power generators 204 to one or more electric storage devices 208 for charging the one or more electric storage devices 208. For example, the microgrid controller 110 may selectively couple a power generator 204 to an electric storage device 208 to charge the electric storage device 208. Thus, the power bus 212 may be part of a power distribution network of the microgrid 200 that may include one or more power buses used to distribute power between loads 108 and/or DERs 202.

The microgrid 200 may include an interface 216 for connecting the microgrid 200 to and disconnecting the microgrid 200 from an electrical power distribution system 218, such as a macrogrid. The electrical power distribution system 218 may include the external controller 104 (e.g., a macrogrid controller), as described in connection with FIG. 1. The external controller 104 may be coupled to the interface 216 for transmitting control signals, such as instructions or requests, to the microgrid controller 110. The interface 216 may include one or more electrical connections used for connecting the microgrid 200 to the electrical power distribution system 218. The interface 216 may include one or more switches or breakers that are controlled by the microgrid controller 110 for connecting the microgrid 200 to and disconnecting the microgrid 200 from the electrical power distribution system 218. For example, the one or more switches or breakers of the interface 216 may connect the power bus 212 (or another system bus) to or disconnect the power bus 212 (or another system bus) from the electrical power distribution system 218. Thus, the microgrid controller 110 may configure the microgrid 200 to operate in a grid-connected mode by connecting the microgrid 200 to the electrical power distribution system 218 or in a stand-alone mode by disconnecting the microgrid 200 from the electrical power distribution system 218.

The microgrid controller 110 may store, in one or more memories, performance data associated with each energy generator system 120 (e.g., each FB energy resource system). The performance data may be related to a performance of each power generator 204 (e.g., each engine). As described above, the performance data may include generator power data, BMEP data, BSFC data, and/or VFC data. The performance data may be stored as one or more performance curves, such as a generator power performance curve, a BMEP performance curve, a BSFC performance curve, and/or a VFC performance curve. The microgrid controller 110 may receive the performance data from the local generator controllers 206 or from an HMI (e.g., HMI 102).

The microgrid controller 110 may calculate, based on the load information, a total load demand required by the plurality of loads. The microgrid controller 110 may use the total load information, along with the performance data, to optimize an efficiency of the power system 106. For example, the microgrid controller 110 may operate the energy generator systems 120 at optimal efficiencies.

The microgrid controller 110 may calculate optimization setpoints based on the performance data. The optimization setpoints may be calculated for operating each energy generator system 120 at a respective peak efficiency over a range of total load demand. The microgrid controller 110 may calculate the optimization setpoints to reduce fuel consumption of energy generator systems 120. The performance data may include one or more performance curves for each energy generator system 120.

In some implementations, the microgrid controller 110 may calculate a set of optimization parameters based on the performance data, the set of optimization parameters being configured to optimize a performance of the microgrid 200. The microgrid controller 110 may determine the optimization setpoints used for operating the energy generator systems 120 based on the set of optimization parameters. In some examples, the optimization setpoints may be used for operating the energy generator systems 120 and the energy storage systems 122. The microgrid controller 110 may generate the control signals based on the optimization setpoints and the total load demand. For example, the microgrid controller 110 may monitor the total load demand against the optimization setpoints, and trigger one or more actions when the total load demand satisfies a corresponding optimization setpoint. Since the optimization setpoints may be related to the total load demand, the optimization setpoints may be referred to as load setpoints.

In some implementations, the microgrid controller 110 may calculate the optimization setpoints based on a mean performance point of each performance curve. For example, the microgrid controller 110 may calculate the set of optimization parameters based on the mean performance point of each performance curve.

In some implementations, the microgrid controller 110 may calculate the optimization setpoints based on an efficiency factor provided to the microgrid controller as a control setpoint. For example, the microgrid controller 110 may calculate the set of optimization parameters based on the efficiency factor provided to the microgrid controller as the control setpoint.

In some implementations, the optimization setpoints include an energy resource add setpoint, an energy resource shed setpoint, a fast add setpoint, a minimum load setpoint, a maximum load setpoint, and/or an SOC setpoint. For example, the energy resource add setpoint may be greater than the energy resource shed setpoint, the fast add setpoint may be greater than the energy resource add setpoint, the energy resource shed setpoint may be greater than the minimum load setpoint, and the maximum load setpoint may be between the energy resource add setpoint and the fast add setpoint.

The energy resource add setpoint may be used by the microgrid controller 110 to trigger adding an additional energy resource system to the microgrid 200 based on the total load demand satisfying the energy resource add setpoint. For example, the microgrid controller 110 may add the additional energy resource system to the microgrid 200 in response to the total load demand being equal to or greater than the energy resource add setpoint. Adding the additional energy resource system may include turning on an additional energy generator system 120 and/or setting an energy storage system 122 to discharge. In some cases, more than one energy resource system may be added.

The energy resource shed setpoint may be used by the microgrid controller 110 to trigger shedding an energy resource system from the microgrid 200 based on the total load demand satisfying the energy resource shed setpoint. For example, the microgrid controller 110 may shed the energy resource system from the microgrid 200 in response to the total load demand being equal to or less than the energy resource add setpoint. Shedding the energy resource system may include turning off an energy generator system 120 and/or disconnecting an energy storage system 122 from the microgrid 200. In some cases, more than one energy resource system may be shedded.

The fast add setpoint may be used by the microgrid controller 110 to trigger adding an additional energy resource system to the microgrid 200 based on detecting a transient load that satisfies the fast add setpoint. For example, the microgrid controller 110 may add the additional energy resource system to the microgrid 200 in response to the total load demand being equal to or greater than the fast add setpoint. Adding the additional energy resource system may include turning on an additional energy generator system 120 and/or setting an energy storage system 122 to discharge. In some cases, more than one energy resource system may be added.

The minimum load setpoint may indicate a minimum load to be allocated, by the microgrid controller 110, to each energy generator system 120. In other words, the microgrid controller 110 may be configured to allocate at least the minimum load to each energy generator system 120. If there is insufficient load available to allocate the minimum load to each energy generator system 120, the microgrid controller 110 may shed one or more energy generator systems 120 from the microgrid 200 such that the minimum load can be allocated to each remaining energy generator system 120. In addition, sufficient excess load should exist prior to turning on an energy generator system 120. For example, the microgrid controller 110 may turn on an additional energy generator system 120 so long as the minimum load can be allocated to the additional energy generator system 120, and so long as the minimum load can still be allocated to any energy generator system 120 currently providing power to the microgrid 200.

The maximum load setpoint may indicate a maximum load to be allocated, by the microgrid controller 110, to each energy generator system 120. In other words, the microgrid controller 110 may be configured to allocate at most the maximum load to each energy generator system 120. If there is insufficient power to satisfy the total load demand when each energy generator system 120 is allocated the maximum load, the microgrid controller 110 may turn on an additional energy generator system 120, set an energy storage system 122 to discharge, and/or draw power from the electrical power distribution system 218 to satisfy an excess of the total load demand that exceeds the maximum load capable of being handled by the current energy generator systems 120.

The SOC setpoint may be used by the microgrid controller 110 to trigger discharging one or more energy storage systems 122 based on an SOC of the one or more energy storage systems 122 satisfying the SOC setpoint. For example, the microgrid controller 110 may set one or more energy storage systems 122 to discharge based on an SOC of the one or more energy storage systems 122 being equal to or greater than the SOC setpoint. Thus, the SOC setpoint may cause the microgrid controller 110 to discharge the one or more energy storage systems 122 based on an SOC of the energy storage systems 122 satisfying the SOC setpoint.

The microgrid controller 110 may monitor the total load demand, compare the total load demand with the energy resource add setpoint, the energy resource shed setpoint, and the fast add setpoint, add a first additional energy resource system to the microgrid 200 based on the total load demand satisfying the energy resource add setpoint, shed the at least one energy resource system from the microgrid 200 based on the total load demand satisfying the energy resource shed setpoint, and add a second additional energy resource system to the microgrid 200 based on detecting the total load demand that satisfies the fast add setpoint.

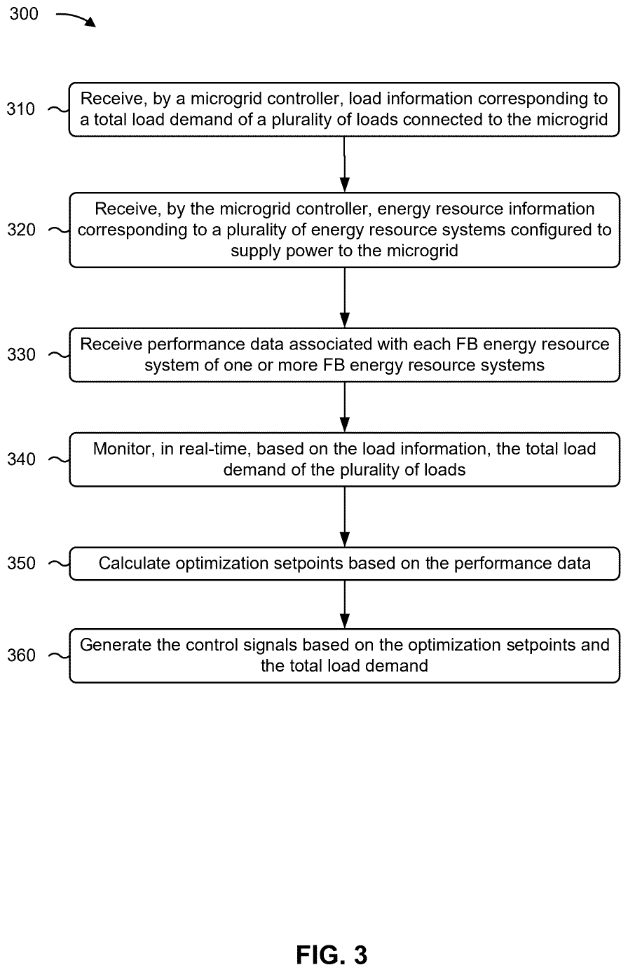

FIG. 3 is a flowchart of an example process 300 associated with energy optimization for load peak shaving with microgrid control systems. One or more process blocks of FIG. 3 may be performed by a microgrid controller (e.g., microgrid controller 110). Additionally, or alternatively, one or more process blocks of FIG. 3 may be performed by another device or a group of devices separate from or including the microgrid controller, such as another device or component that is internal or external to a microgrid. For example, one or more process blocks of FIG. 3 may be performed by an HMI.

As shown in FIG. 3, process 300 may include receiving load information corresponding to a total load demand of a plurality of loads connected to the microgrid (block 310). For example, the microgrid controller 110 may receive load information corresponding to the total load demand of a plurality of loads connected to the microgrid, as described above.

As further shown in FIG. 3, process 300 may include receiving energy resource information corresponding to a plurality of energy resource systems configured to supply power to the microgrid (block 320). For example, the microgrid controller 110 may receive energy resource information corresponding to a plurality of energy resource systems configured to supply power to the microgrid. The plurality of energy resource systems may include one or more FB energy resource systems configured to generate power to be supplied to the microgrid and one or more ESSs configured to be charged and discharged.

As further shown in FIG. 3, process 300 may include receiving performance data associated with each FB energy resource system of the one or more FB energy resource systems (block 330). For example, the microgrid controller 110 may receive the performance data, as described above.

As further shown in FIG. 3, process 300 may include monitoring, in real-time, based on the load information, the total load demand of the plurality of loads (block 340). For example, the microgrid controller 110 may monitor, in real-time, based on the load information, the total load demand of the plurality of loads, as described above.

As further shown in FIG. 3, process 300 may include calculating optimization setpoints based on the performance data (block 350). For example, the microgrid controller 110 may calculate optimization setpoints based on the performance data, as described above. The optimization setpoints may be calculated for operating each FB energy resource system of the one or more FB energy resource systems at a respective peak efficiency over a range of total load demand.

As further shown in FIG. 3, process 300 may include generating the control signals based on the optimization setpoints and the total load demand (block 360). For example, the microgrid controller 110 may generate the control signals based on the optimization setpoints and the total load demand, as described above.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

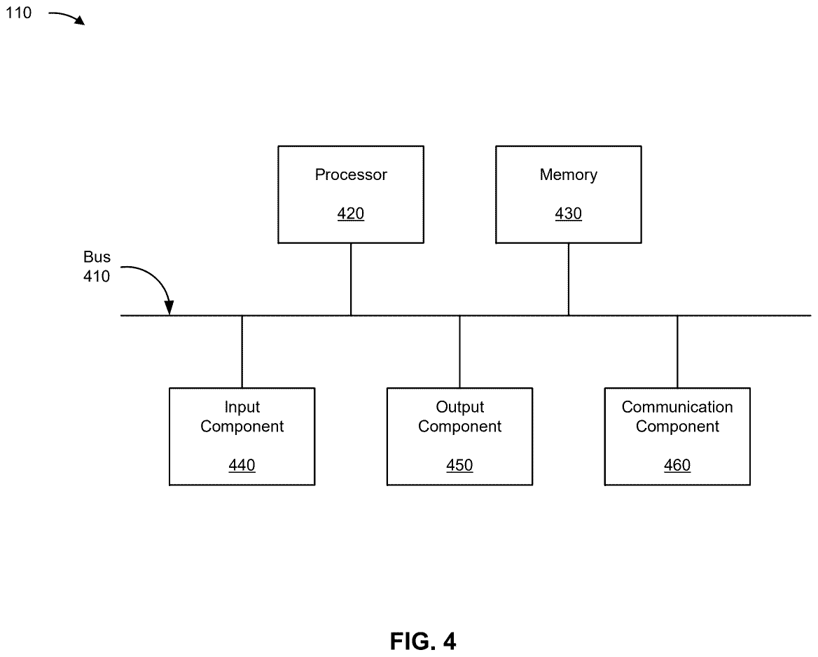

FIG. 4 is a diagram of example components of the microgrid controller 110 energy optimization for load peak shaving with microgrid control systems. The microgrid controller 110 may include a bus 410, a processor 420, a memory 430, an input component 440, an output component 450, and/or a communication component 460.

The bus 410 may include one or more components that enable wired and/or wireless communication among the components of the microgrid controller 110. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus.

The processor 420 may include a central processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. The processor 420 may include one or more processors capable of being programmed to perform one or more operations or processes described elsewhere herein. The processor 420 may monitor, in real-time, based on the load information, the total load demand of the plurality of loads. The processor 420 may calculate optimization setpoints based on performance data associated with FB energy resource systems. The processor 420 may generate the control signals based on the optimization setpoints and the total load demand, as described above.

The memory 430 may store information, one or more instructions and/or software (e.g., one or more software applications) related to the operation of the microgrid controller 110. For example, the memory 430 may store performance data associated with each FB energy resource system. The memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the microgrid controller 110 to receive input, load information, generator data, energy storage data, status information, scheduling information, performance data, and/or control signals (e.g., control signals from a macrogrid controller). The output component 450 may enable the microgrid controller 110 to provide output, such as one or more control signals for controlling loads, energy storage systems, breakers, switches, and other components associated with the microgrid described herein. The communication component 460 may enable the microgrid controller 110 to communicate with other devices via a wired connection and/or a wireless connection. For example, the communication component 460 may include a receiver, a transmitter, and/or a transceiver.

The microgrid controller 110 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. Execution of the set of instructions, by one or more processors 420, may cause the one or more processors 420 and/or the microgrid controller 110 to perform one or more operations or processes described herein. Hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

### INDUSTRIAL APPLICABILITY

A power distribution system, such as a microgrid, may include fuel-based DERs (e.g., generator sets) and energy storage systems (e.g., batteries and capacitors). A microgrid controller described herein may provide an efficient way to optimize usage of fuel by optimizing usage of the fuel-based DERs within the power distribution system and by operating the fuel-based DERs at respective peak efficiency points over a range of total load demand. The microgrid controller may store performance data, associated with each fuel-based DER, that may be used to operate the fuel-based energy resource systems at optimal efficiency to satisfy total load demands of the microgrid system.

1. A microgrid controller of a microgrid, comprising:
a communication interface configured to receive load information corresponding to a plurality of loads connected to the microgrid, receive energy resource information corresponding to a plurality of energy resource systems connected to the microgrid, and output control signals for controlling an operation of each energy resource system of the plurality of energy resource systems, wherein the plurality of energy resource systems includes one or more fuel-based (FB) energy resource systems configured to generate power to be supplied to the microgrid and one or more energy storage systems (ESSs) configured to be charged and discharged;
one or more memories configured to store performance data associated with each FB energy resource system of the one or more FB energy resource systems, wherein the performance data comprises fuel-efficiency data defining operating load ranges at which fuel consumption per unit of generated power is minimized; and
one or more processors, coupled to the one or more memories, configured to:
calculate, based on the load information, a total load demand required by the plurality of loads,
calculate target operating load ranges for the one or more FB energy resource systems based on the fuel-efficiency data,
determine load setpoints for the one or more FB energy resource systems and the one or more ESSs based on the total load demand and the target operating load ranges, and
generate the control signals based on the load setpoints.

2. The microgrid controller of claim 1, wherein the one or more FB energy resource systems are engine generators, and
wherein the communication interface is configured to receive the performance data from the one or more FB energy resource systems, and store the performance data in the one or more memories.

3. The microgrid controller of claim 1, wherein the one or more processors are configured to calculate the target operating load ranges based on an efficiency factor provided to the microgrid controller as a control setpoint.

4. The microgrid controller of claim 1, wherein the performance data includes, for each FB energy resource system of the one or more FB energy resource systems, generator power data, break specific fuel consumption (BSFC) data, and volumetric fuel consumption data.

5. The microgrid controller of claim 1, wherein the performance data includes one or more performance curves for each FB energy resource system of the one or more FB energy resource systems, wherein the one or more performance curves include at least one of a generator power performance curve, a brake mean effective pressure (BMEP) performance curve, a break specific fuel consumption (BSFC) performance curve, or a volumetric fuel consumption performance curve.

6. The microgrid controller of claim 1, wherein the performance data includes one or more performance curves for each FB energy resource system of the one or more FB energy resource systems, and
wherein the one or more processors are configured to calculate the target operating load ranges based on a mean performance point of each performance curve of the one or more performance curves.

7. The microgrid controller of claim 1, wherein the load setpoints include at least one of:
an energy resource add setpoint for triggering the one or more processors to add a first additional energy resource system to the microgrid to the microgrid to maintain operation of the one or more FB energy resource systems within the target operating load ranges based on the total load demand satisfying the energy resource add setpoint,
an energy resource shed setpoint for triggering the one or more processors to shed an energy resource system from the microgrid while maintaining the one or more FB energy resource systems within the target operating load ranges based on the total load demand satisfying the energy resource shed setpoint,
a fast add setpoint for triggering the one or more processors to add a second additional energy resource system to the microgrid based on detecting a transient load that satisfies the fast add setpoint,
a minimum load setpoint for indicating a minimum load to be allocated, by the one or more processors, to each FB energy resource system of the one or more FB energy resource systems within a corresponding target operating load range,
a maximum load setpoint for indicating a maximum load to be allocated, by the one or more processors, to each FB energy resource system of the one or more FB energy resource systems within a corresponding target operating load range, or
a state-of-charge (SOC) setpoint for triggering the one or more processors to discharge the one or more ESSs to cause the one or more ESSs to discharge to maintain the one or more FB energy resource systems within the target operating load ranges based on an SOC of the one or more ESSs satisfying the SOC setpoint.

8. The microgrid controller of claim 7, wherein the energy resource add setpoint is greater than the energy resource shed setpoint,
wherein the fast add setpoint is greater than the energy resource add setpoint,
wherein the energy resource shed setpoint is greater than the minimum load setpoint, and
wherein the maximum load setpoint is between the energy resource add setpoint and the fast add setpoint to maintain the one or more FB energy resource systems within the target operating load ranges.

9. The microgrid controller of claim 1, wherein one or more processors are configured to calculate the load setpoints to operate each FB energy resource system of the one or more FB energy resource systems at a respective peak efficiency.

10. The microgrid controller of claim 1, wherein one or more processors are configured to calculate the load setpoints to reduce fuel consumption of the one or more FB energy resource systems.

11. A microgrid controller of a microgrid, comprising:
a communication interface configured to receive load information corresponding to a plurality of loads connected to the microgrid, receive energy resource information corresponding to a plurality of energy resource systems connected to the microgrid, and output control signals for controlling an operation of each energy resource system of the plurality of energy resource systems, wherein the plurality of energy resource systems includes one or more fuel-based (FB) energy resource systems configured to generate power to be supplied to the microgrid and one or more energy storage systems (ESSs) configured to be charged and discharged;
one or more memories configured to store performance data associated with each FB energy resource system of the one or more FB energy resource systems; and
one or more processors, coupled to the one or more memories, configured to:
calculate, based on the load information, a total load demand required by the plurality of loads,
calculate optimization setpoints based on the performance data for a selected load configuration of the microgrid defining a fixed combination of energy resource systems, wherein the optimization setpoints define thresholds for controlling addition, shedding, or fast addition of energy resource systems and state-of-charge (SOC) control of the one or more ESSs for the selected load configuration, and
generate the control signals based on the optimization setpoints and the total load demand.

12. The microgrid controller of claim 11, wherein the performance data includes, for each FB energy resource system of the one or more FB energy resource systems, generator power data, break specific fuel consumption (BSFC) data, and volumetric fuel consumption data.

13. The microgrid controller of claim 11, wherein the performance data includes one or more performance curves for each FB energy resource system of the one or more FB energy resource systems, wherein the one or more performance curves include at least one of a generator power performance curve, a brake mean effective pressure (BMEP) performance curve, a break specific fuel consumption (BSFC) performance curve, or a volumetric fuel consumption performance curve.

14. The microgrid controller of claim 11, wherein the performance data includes one or more performance curves for each FB energy resource system of the one or more FB energy resource systems, and
wherein the one or more processors are configured to calculate the optimization setpoints based on a mean performance point of each performance curve of the one or more performance curves.

15. The microgrid controller of claim 11, wherein the optimization setpoints include:
an energy resource add setpoint for triggering the one or more processors to add a first additional energy resource system to the microgrid based on the total load demand satisfying the energy resource add setpoint,
an energy resource shed setpoint for triggering the one or more processors to shed an energy resource system from the microgrid based on the total load demand satisfying the energy resource shed setpoint,
a fast add setpoint for triggering the one or more processors to add a second additional energy resource system to the microgrid based on detecting a transient load that satisfies the fast add setpoint,
a minimum load setpoint for indicating a minimum load to be allocated, by the one or more processors, to each FB energy resource system of the one or more FB energy resource systems,
a maximum load setpoint for indicating a maximum load to be allocated, by the one or more processors, to each FB energy resource system of the one or more FB energy resource systems, and
a state-of-charge (SOC) setpoint for triggering the one or more processors to discharge the one or more ESSs based on an SOC of the one or more ESSs satisfying the SOC setpoint.

16. The microgrid controller of claim 11, wherein the optimization setpoints include:
an energy resource add setpoint for triggering the one or more processors to add a first additional energy resource system to the microgrid based on the total load demand satisfying the energy resource add setpoint,
an energy resource shed setpoint for triggering the one or more processors to shed at least one energy resource system from the microgrid based on the total load demand satisfying the energy resource shed setpoint, and
a fast add setpoint for triggering the one or more processors to add a second additional energy resource system to the microgrid based on detecting a transient load that satisfies the fast add setpoint,
wherein the energy resource add setpoint is greater than the energy resource shed setpoint, and
wherein the fast add setpoint is greater than the energy resource add setpoint.

17. The microgrid controller of claim 16, wherein the one or more processors are configured to:
monitor the total load demand and compare the total load demand with the energy resource add setpoint, the energy resource shed setpoint, and the fast add setpoint,
add the first additional energy resource system to the microgrid based on the total load demand satisfying the energy resource add setpoint,
shed the at least one energy resource system from the microgrid based on the total load demand satisfying the energy resource shed setpoint, and
add the second additional energy resource system to the microgrid based on detecting the total load demand that satisfies the fast add setpoint.

18. The microgrid controller of claim 11, wherein the optimization setpoints include:
a minimum load setpoint for indicating a minimum load to be allocated, by the one or more processors, to each FB energy resource system of the one or more FB energy resource systems, and
a maximum load setpoint for indicating a maximum load to be allocated, by the one or more processors, to each FB energy resource system of the one or more FB energy resource systems.

19. The microgrid controller of claim 11, wherein the optimization setpoints include:
a state-of-charge (SOC) setpoint for causing the one or more processors to discharge the one or more ESSs based on an SOC of the one or more ESSs satisfying the SOC setpoint.

20. A method for controlling assets of a microgrid, comprising:
receiving, by a microgrid controller of a microgrid, load information corresponding to a total load demand of a plurality of loads connected to the microgrid;
receiving, by the microgrid controller, energy resource information corresponding to a plurality of energy resource systems configured to supply power to the microgrid, wherein the plurality of energy resource systems includes one or more fuel-based (FB) energy resource systems configured to generate power to be supplied to the microgrid and one or more energy storage systems (ESSs) configured to be charged and discharged;
receiving performance data associated with each FB energy resource system of the one or more FB energy resource systems;
monitoring, in real-time, based on the load information, the total load demand of the plurality of loads;
calculating optimization setpoints based on the performance data for a selected load configuration of the microgrid defining a fixed combination of energy resource systems, wherein the optimization setpoints define thresholds for controlling addition, shedding. or fast addition of energy resource systems and state-of-charge (SOC) control of the one or more ESSs for the selected load configuration; and
generating the control signals based on the optimization setpoints and the total load demand.
